(19) United States
(12) Patent Application Publication
(10) Pub. No.: US 2021/0090336 A1
(43) Pub. Date: Mar. 25, 2021

(54) REMOTE ASSISTANCE SYSTEM

(71) Applicant: YUTOU TECHNOLOGY (HANGZHOU) CO., LTD., Hangzhou City (CN)

(72) Inventors: Zhiyu HUO, Hangzhou City (CN); Cheng LU, Hangzhou City (CN); Lingyu WANG, Hangzhou City (CN)

(21) Appl. No.: 16/583,068

(22) Filed: Sep. 25, 2019

(51) Int. Cl. G06T 19/00

(52) U.S. Cl. CPC G06T 19/006; G06T 2219/024; G06T 2219/004

(57) ABSTRACT

Aspects for remote assistance systems including a virtual reality (VR), an augmented reality (AR), or a mixed reality (MR) system (collectively “wearable visual enhancement device”) are described herein. As an example, the aspects may include a wearable visual enhancement device at a first location configured to scan a scene in a real world in a forward field-of-view of a first user, generate sensor data associated with one or more objects in the scene and transmit the sensor data to a computing system at a second location. The computing system at the second location may be configured to generate a 3D scene including 3D models of the one or more objects, receive a mark associated with one of the 3D models, and transmit information that identifies the mark to the wearable visual enhancement device. The wearable visual enhancement device may be configured to display the mark adjacent to the object.

### BACKGROUND

A wearable visual enhancement device may refer to a head-mounted device that provides supplemental information associated with real-world objects. For example, the wearable visual enhancement device may include a near-eye display configured to display supplemental information. For instance, a movie schedule may be displayed by a movie theater such that the user may not need to search for movie information when he/she sees the movie theater. In another example, a name of a perceived real-world object may be displayed adjacent to the object or overlapped with the object.

Some available wearable visual enhancement devices may further include integrated processing units configured to run pattern recognition algorithms to recognize real-world objects prior to determining the content of the supplemental information. In some other examples, some wearable visual enhancement devices may be configured to generate 3D models of the real-world objects based on collected sensor data.

However, such algorithms may cause high power consumption, while running on the wearable visual enhancement devices, and further reduce the battery life.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

One example aspect of the present disclosure provides an example remote assistance system. The example aspect may include a wearable visual enhancement device at a first location configured to scan a scene in a real world in a forward field-of-view of a first user, generate sensor data associated with one or more objects in the scene, and transmit the sensor data. The example aspect may further include a computing system at a second location configured to receive the sensor data, generate a 3D scene including 3D models of the one or more objects, receive, via input by a second user, a mark associated with one of the 3D models, and transmit information that identifies the mark to the wearable visual enhancement device. The wearable visual enhancement device may be further configured to display the mark adjacent to the object corresponding to the one of the 3D models.

Another example aspect of the present disclosure provides an example method for remote assistance. The example method may include scanning, by a wearable visual enhancement device at a first location, a scene in a real world in a forward field-of-view of a first user; generating, by the wearable visual enhancement device, sensor data associated with one or more objects in the scene; generating, by a computing system at a second location, a 3D scene including 3D models of the one or more objects; receiving, via input to the computing system by a second user, a mark associated with one of the 3D models; transmitting, by the computing system, information that identifies the mark to the wearable visual enhancement device; and displaying, by the wearable visual enhancement device, the mark adjacent to the object corresponding to the one of the 3D models.

To the accomplishment of the foregoing and related ends, the one or more aspects comprise the features herein after fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example wearable visual enhancement device in an example remote assistance system in accordance with the present disclosure;

FIG. 2 illustrates an example remote assistance system in accordance with the present disclosure;

FIG. 3 illustrates components of an example wearable visual enhancement device in an example remote assistance system in accordance with the present disclosure;

FIG. 4 illustrates components of an example computing system in an example remote assistance system in accordance with the present disclosure; and

FIG. 5 is a flow chart of an example method for remote assistance in accordance with the present disclosure.

### DETAILED DESCRIPTION

Various aspects are now described with reference to the drawings. In the following description, for the purpose of explanation, numerous specific details are set forth in order to provide a thorough understanding of one or more aspects. It may be evident, however, that such aspect(s) may be practiced without these specific details.

In the present disclosure, the term “comprising” and “including” as well as their derivatives mean to contain rather than limit; the term “or”, which is also inclusive, means and/or.

In this specification, the following various embodiments used to illustrate principles of the present disclosure are only for illustrative purpose, and thus should not be understood as limiting the scope of the present disclosure by any means. The following description taken in conjunction with the accompanying drawings is to facilitate a thorough understanding to the illustrative embodiments of the present disclosure defined by the claims and its equivalent. There are specific details in the following description to facilitate understanding. However, these details are only for illustrative purpose. Therefore, persons skilled in the art should understand that various alternation and modification may be made to the embodiments illustrated in this description without going beyond the scope and spirit of the present disclosure. In addition, for clear and concise purpose, some known functionality and structure are not described. Besides, identical reference numbers refer to identical function and operation throughout the accompanying drawings.

A remote assistance system disclosed hereinafter may include a wearable visual enhancement device at a first location and a computing system at a second location. While a first user is wearing the wearable visual enhancement device, the wearable visual enhancement device may be configured to scan real-world objects in a forward field-of-view of the first user. Sensor data associated with the real-world objects may be transmitted from the wearable visual enhancement device to the computing system via the internet or other wireless transmission protocols. The computing system may be configured to generate a 3D scene that includes 3D models of the objects. A second user may input marks of one or more of the objects. The marks may include lines and curves to emphasize the objects or annotations to describe the objects. Information that identifies the marks may be transmitted back to the wearable visual enhancement device. The wearable visual enhancement device may be configured to display the mark adjacent to the real-world object in the field-of-view of the first user.

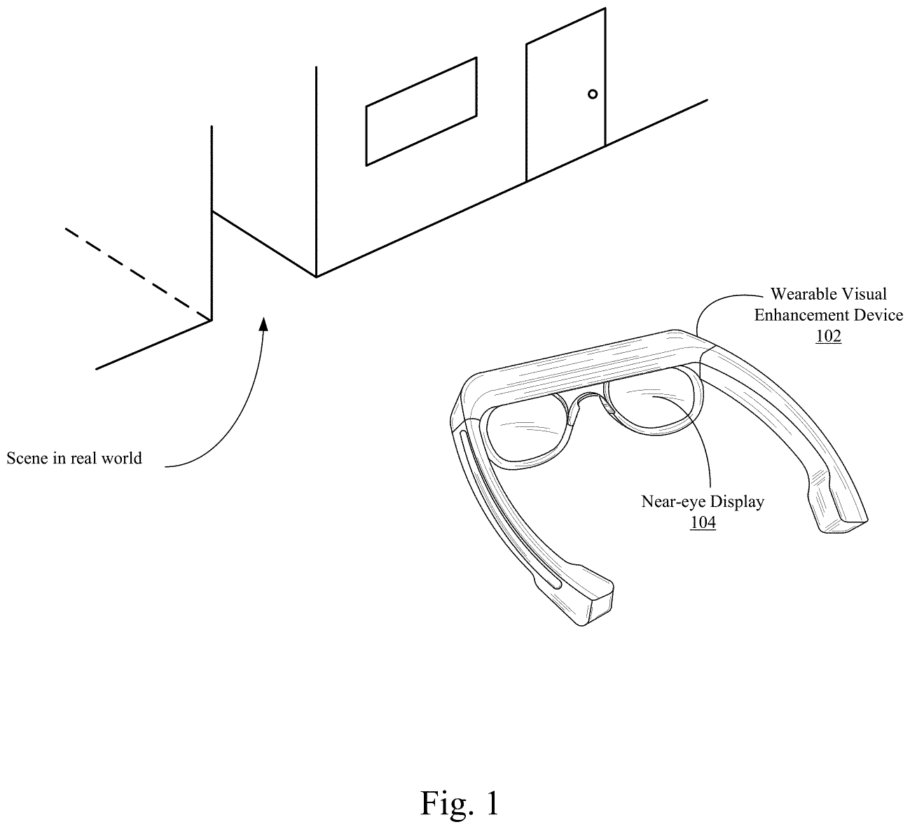

FIG. 1 illustrates an example wearable visual enhancement device in an example remote assistance system in accordance with the present disclosure. As depicted, a wearable visual enhancement device 102 at a first location, while being worn by a first user (not shown), may be configured to scan a scene in a real world in a forward field-of-view of the first user. The real-world scene may include one or more objects, e.g., walls, windows, doors, floors. In some examples, the wearable visual enhancement device 102 may be configured to collect color information and distance information of the objects periodically, e.g., at 30 Hz. The distance information may include respective distances from different portions of each object to the wearable visual enhancement device 102.

Further to the examples, the wearable visual enhancement device 102 may be configured to monitor and record acceleration and angular velocity of the wearable visual enhancement device 102 periodically at a predetermined rate. Based on the acceleration and angular velocity, the wearable visual enhancement device 102 may be configured to determine the position of the wearable visual enhancement device 102 in six degrees of freedom (“6 DoF information” hereinafter), e.g., three degrees of freedom by quaternion and another three degrees of freedom by Cartesian system, and the orientation of the wearable visual enhancement device 102.

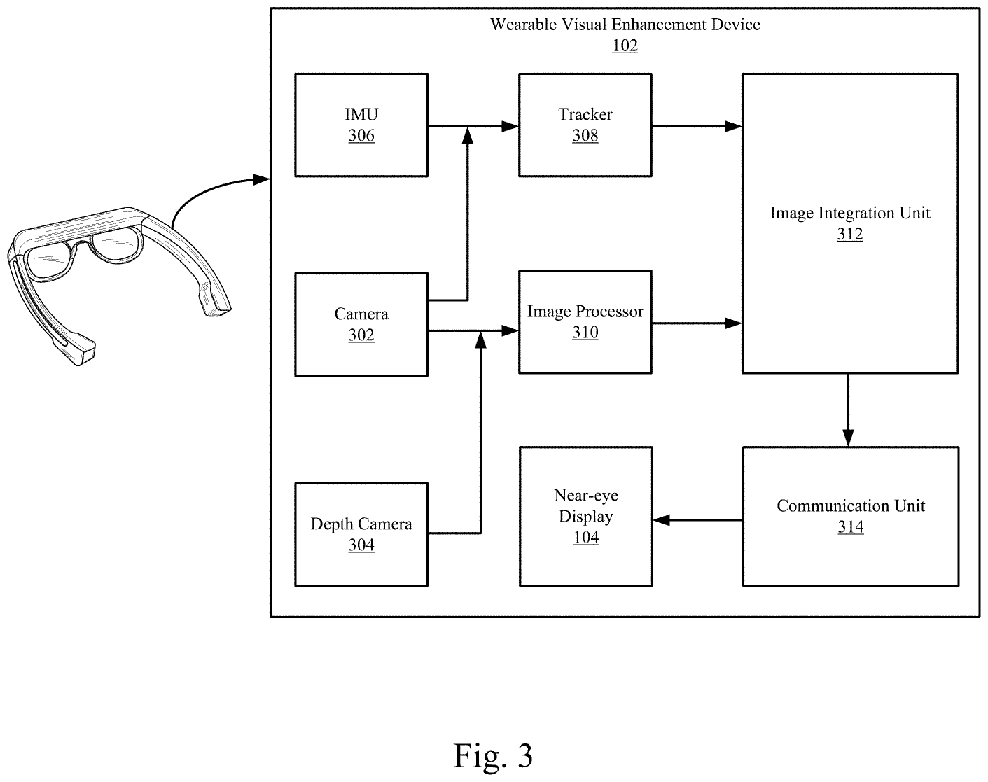

In some examples, a communication unit of the wearable visual enhancement device 102 may be configured to transmit the collected color information and the distance information, together with the 6 DoF information (collectively “sensor data”), to a computing system at a second location via the internet or other wireless communication protocols. Details of the wearable visual enhancement device 102 are described in accordance with FIG. 3.

Supplemental information or marks received externally may be displayed at a near-eye display 104 of the wearable visual enhancement device 102.

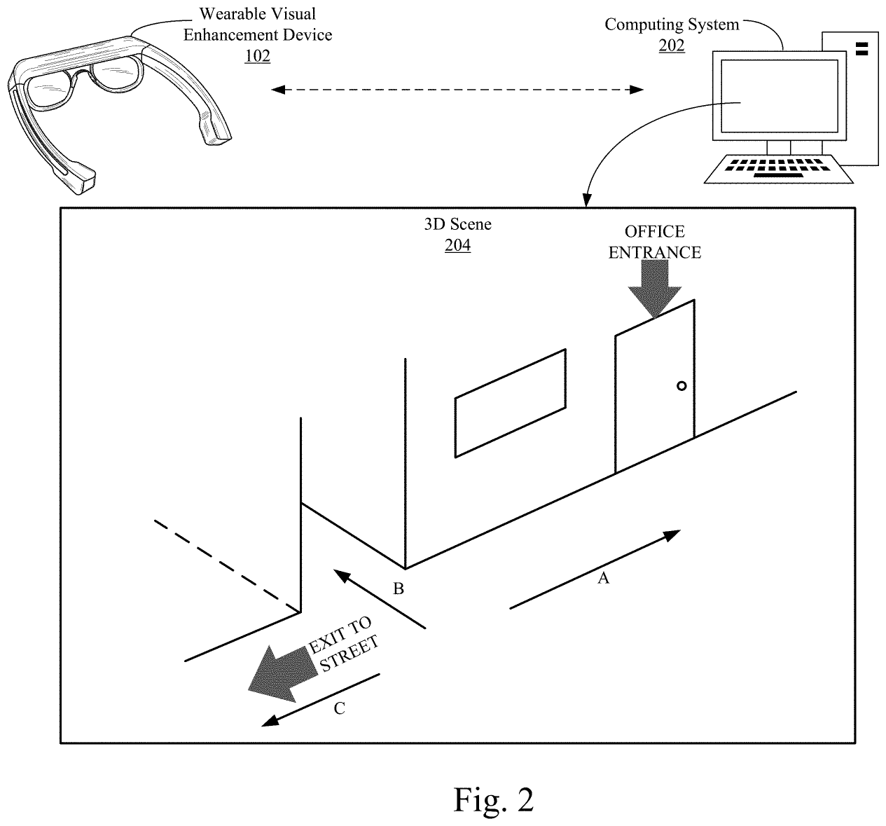

FIG. 2 illustrates an example remote assistance system in accordance with the present disclosure. As depicted, a computing system 202 at a second location may include another communication unit configured to receive the color information, the distance information, and the 6 DoF information. Based on the color information, the distance information, and the 6 DoF information, the computing system 202 may be configured to generate a colored 3D scene 204 including 3D models of the real-world objects. A display of the computing system 202 may be configured to display the 3D scene 204 such that a second user may view the 3D scene 204 at the display.

In some examples, the computing system 202 may receive marks regarding the real-world objects input by the second user. In some examples, the marks may include annotations. For example, the second user may annotate the door as “OFFICE ENTRANCE” as shown in FIG. 2 and the direction to the lower left corner of the display as “EXIT TO STREET.” The annotations may be displayed adjacent to the 3D models of the door and the floor at the lower left corner with arrows to further describe the objects. In some other examples, the marks may include lines, curves, or circles. For example, the second user may circle the doorknob to remind the first user of the office entrance. Further to the examples, information that identifies the marks may be transmitted back to the wearable visual enhancement device 102. The wearable visual enhancement device 102 may then be configured to display the marks sufficiently adjacent to the real-world objects in a near-eye display. In other words, from the perspective of the first user, the marks are displayed adjacent to the real-world objects in the field-of-view of the first user. As such, the first user may receive additional information from the second user regarding objects in the first user's field-of-view.

In some examples, the computing system 202 may receive marks regarding the real-world objects from the wearable visual enhancement device 102 input by the first user. The mark may be associated with one object and transmitted together with the object information. In one example, the marks may be first generated by the first user and transmitted to the computing system 202 by the communication unit of the wearable visual enhancement device 102. In another example, the marks may be revised or edited by the first user based on a mark transmitted from the computing system 202. The first user may generate or edit a mark through various human-machine interactions, such as gesture recognition or voice interaction. As such, the first user and second user may facilitate communication by sharing and co-editing the marks in the field-of-view.

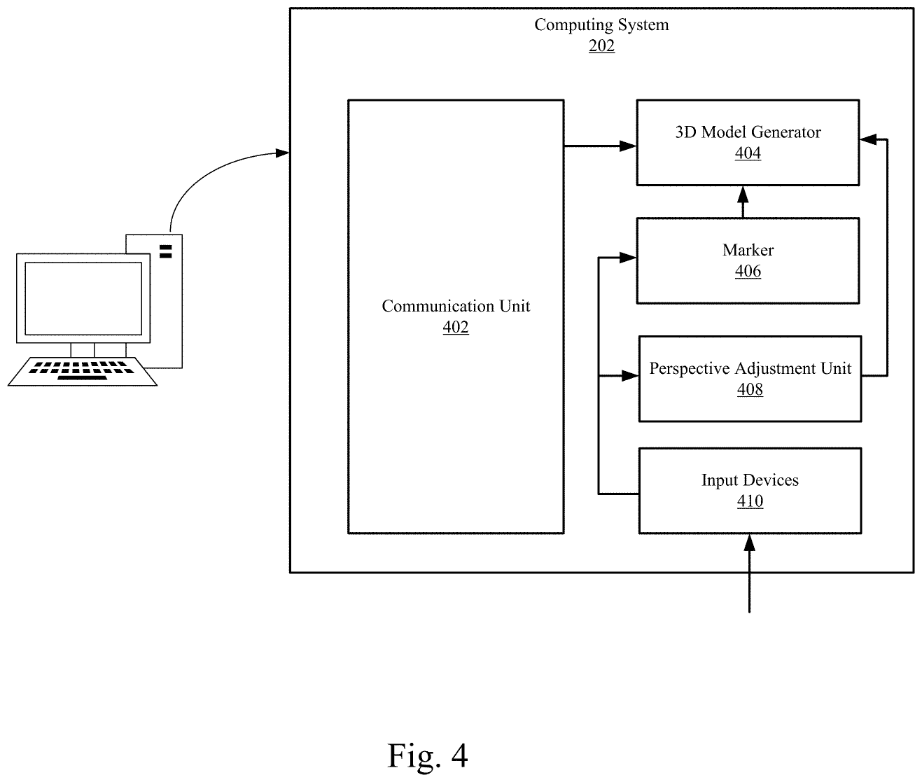

In some examples, the computing system 202 may be configured to receive inputs from the second user to adjust the perspective in the 3D scene. The computing system 202 may accordingly change the perspective, for example, toward the direction marked as “A” such that the second user or other viewers may see the door more closely. Notably, the computing system 202 may be configured to adjust the perspective in the 3D scene along other directions that are not limited by the marked directions in FIG. 2. For example, the computing system 202 may elevate the perspective in the 3D scene such that the second user or other viewers may see the 3D models from above. Details of the computing system 202 are described in accordance with FIG. 4.

FIG. 3 illustrates components of an example wearable visual enhancement device in an example remote assistance system in accordance with the present disclosure.

As depicted, the wearable visual enhancement device 102 may include a camera 302, a depth camera 304, and an inertial measurement unit (IMU) 306, which may be collectively referred to as “simultaneous localization and mapping (SLAM) unit.” The IMU 306 may include an accelerometer and a gyroscope and may be configured to collect acceleration and angular velocity of the wearable visual enhancement device 102 periodically at a first predetermined rate, e.g., 200 Hz. Each collected acceleration and angular velocity may be associated with a timestamp that identifies the time of the collection. The camera 302 may be configured to collect color information of the first user's field-of-view at a second predetermined rate, e.g., 30 frames per second (fps). Similarly, each collected color frame may be associated with a timestamp. In some examples, each color frame may be in 640×480 resolution with three channels, respectively red, green, blue, each in 24 bits. The depth camera 304 may be configured to collect distance information of the first user's field-of-view, e.g., depth image, at a third predetermined rate, e.g., 30 fps. The distance information may include the distances from different real-world objects (or different parts of a real-world object) to the wearable visual enhancement device 102. Each depth image may be in 640×480 resolution. The collected distances may be within a range from 0 to 4096 mm. The first, the second, and the third predetermined rates may refer to one predetermined rate in some examples. In some other examples, the first, the second, and the third predetermined rates may respectively refer to different predetermined rates.

In some non-limiting examples, the collected sensor data may be formatted in the following formats:

RGB image format:
Resolution: 640×480.
Color channel: 3 channels, 8 bits per color, 24 bits per pixel.
Value range: 0˜255.
Image size: 7372800 bits.

Depth image format:
Resolution: 640×480
Color channel: 1 change 16 bits per pixel.
Value range: 0˜4096.
Unit: millimeter.
Image size: 4915200 bits.

Acceleration and angular velocity:
Accelerometer data (3-element vector): [ax, ay, az]. Unit: m\hat{ }2/s
Gyroscope data (3-element vector): [gx, gy, gz]. Unit: rad/s 6 DoF information:
A 6 DoF data frame consists of 7 float numbers, 4 for the orientation in quaternion form and 3 in cartesian position form:
   Orientation: [w, x, y, z] quaternion form
   Position: [x, y, z]/m. (by meter)

The wearable visual enhancement device 102 may further include a tracker 308 and an image processor 310. In some examples, the tracker 308 may be configured to generate the 6 DoF information based at least partially on the acceleration and angular velocity and the color images in accordance with simultaneous localization and mapping (SLAM) algorithms. The image processor 310 may be configured to combine the collected depth images with the color images to generate images that include both color information and distance information (“RGB-D” images hereinafter).

The wearable visual enhancement device 102 may further include an image integration unit 312 configured to combine the 6 DoF information, the color images, and the depth images into one or more frames. In more details, the image integration unit 312 may be configured to combine the color image, the depth image, and the 6 DoF information that share a same timestamp into one frame. The frames may be generated by the image integration unit 312 in accordance with a frame format that include a frame ID, a frame timestamp, the 6 DoF information, the color image, and the depth image. In at least some examples, the color image and the depth image may be respectively compressed in accordance with a compression standard, e.g., JPEG. The generated frames may be transmitted to a communication unit 314. The communication unit 314 may be configured to transmit the frames via the internet in accordance with wireless communication protocols, e.g., 4G/5G/Wi-Fi, to the computing system 202 in real time.

In some examples, the communication unit 314 may be configured to receive information that identifies the marks from the computing system 202. The information may be delivered by the communication unit 314 to the near-eye display 104. The near-eye display 104 may be configured to display the marks adjacent to the corresponding objects in the first user's field-of-view.

FIG. 4 illustrates components of an example computing system in an example remote assistance system in accordance with the present disclosure. As depicted, the computing system 402 may include a communication unit 402 configured to receive the frames including the color image, the depth image, and the 6 DoF information and, further, transmit the frames to a 3D model generator 404.

In at least some examples, the 3D model generator 404 may be configured to generate a 3D scene, e.g., 3D scene 204, based on the received DoF information, the color information, and the distance information. In more details, the 3D model generator 404 may be configured to associate color information of each pixel in the color image with each corresponding pixel in the depth image. Further, the 3D model generator 404 may convert the depth image with the associated color information into colored point cloud based on the pinhole camera model and further transform the colored point cloud from a camera ego coordinate to a SLAM coordinate based on the 6 DoF information. The 3D model generator 404 may then merge the colored point cloud to a 3D scene point cloud and score 3D points in the point cloud by the probability observed in the depth image. Outliner and 3D points with low scores, e.g., lower than a threshold, may be removed by the 3D model generator 404. Further, the 3D model generator 404 may be configured to generate a colored mesh model based on the colored point cloud.

The 3D model generator 404 may be configured to further render the colored mesh model in accordance with OpenGL (Open Graphics Library) and, thus, allow the second user to change the perspective in the 3D scene 204 with input devices 410, e.g., mouse, keyboard, etc. For example, a perspective adjustment unit 408 may receive control signals from the input devices 410, e.g., movement of mouse from left to right. In response to the control signals, the perspective adjustment unit 408 may be configured to pan the perspective from left to right.

The computing system 202 may further include a marker 406. Upon receiving inputs (e.g., drawing of a mark) from the second user via the input devices 410, the marker 406 may be configured to convert the trajectory of the drawing into a mesh model that may be further transmitted back to the wearable visual enhancement device 102 with information that identifies the mark and the corresponding object. With respect to text inputs, the marker 406 may generate texts accordingly and transmit the texts to the 3D model generator 404 such that the texts may be included in the 3D scene. Similarly, the texts may be transmitted back to the wearable visual enhancement device 102 with information that identifies the corresponding object.

In some non-limiting examples, the annotation or mark may be formed in accordance with the following formats.
Vertices: The vertices vector represents all the triangulars of the mesh. Each triangular is represented by three vertices, and each vertex is represented by three float numbers of the x, y, and z coordinate.
   {(x1, y1, z1), (x2, y2, z2), (x3, y3, z3)}_{triangular1}, (x2, y2, z2), (x4, y4, z4), . . . .
   The length of the vertices vectors that need to be transmitted is 3×N, N is the number of the triangles. The data size is 3×3×N×32 bits=288N bits.
Colors: The color vector describe the color information of each vertex in the vertices vector by the red, green and blue components.
   {(r1, g1, b1), (r2, g2, b2), (r3, g3, b3)}_{triangular1}, (r2, g2, b2), (r4, g4, b4), . . . .
   The data size is 3×3×N×24 bits=216N bits, N is the number of the triangles.

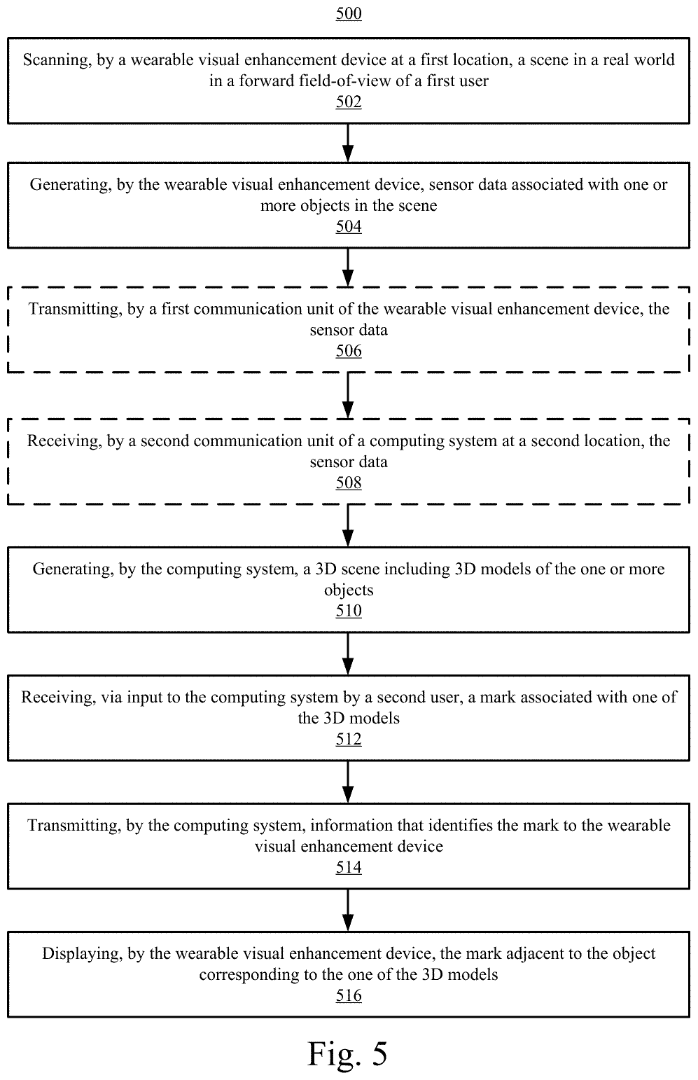

FIG. 5 is a flow chart of an example method for remote assistance in accordance with the present disclosure. Operations included in the example method 500 may be performed by the components described in accordance with FIGS. 1-4. Dash-lined blocks may indicate optional operations.

At block 502, example method 500 may include scanning, by a wearable visual enhancement device at a first location, a scene in a real world in a forward field-of-view of a first user. For example, the wearable visual enhancement device 102 at a first location, while being worn by a first user (not shown), may be configured to scan a scene in a real world in a forward field-of-view of the first user.

At block 504, example method 500 may include generating, by the wearable visual enhancement device, sensor data associated with one or more objects in the scene. For example, the wearable visual enhancement device 102 may include the camera 302, the depth camera 304, and the IMU 306. The IMU 306 may include an accelerometer and a gyroscope and may be configured to collect acceleration and angular velocity of the wearable visual enhancement device 102 periodically at a first predetermined rate, e.g., 200 Hz. The camera 302 may be configured to collect color information of the first user's field-of-view at a second predetermined rate, e.g., 30 frames per second (fps). The depth camera 304 may be configured to collect distance information of the first user's field-of-view, e.g., depth image, at a third predetermined rate, e.g., 30 fps.

At block 506, example method 500 may include transmitting, by a first communication unit of the wearable visual enhancement device, the sensor data. For example, the communication unit 314 may be configured to transmit the sensor data via the internet in accordance with wireless communication protocols, e.g., 4G/5G/Wi-Fi, to the computing system 202 in real time.

At block 508, example method 500 may include receiving, by a second communication unit of a computing system at a second location, the sensor data. For example, the computing system 402 may include a communication unit 402 configured to receive the frames including the color image, the depth image, and the 6 DoF information and, further, transmit the frames to a 3D model generator 404.

At block 510, example method 500 may include generating, by the computing system, a 3D scene including 3D models of the one or more objects. For example, the 3D model generator 404 may be configured to generate a 3D scene, e.g., 3D scene 204, based on the received DoF information, the color information, and the distance information. In more details, the 3D model generator 404 may be configured to associate color information of each pixel in the color image with each corresponding pixel in the depth image. Further, the 3D model generator 404 may convert the depth image with the associated color information into colored point cloud based on the pinhole camera model and further transform the colored point cloud from a camera ego coordinate to a SLAM coordinate based on the 6 DoF information. The 3D model generator 404 may then merge the colored point cloud to a 3D scene point cloud and score 3D points in the point cloud by the probability observed in the depth image. Outliner and 3D points with low scores, e.g., lower than a threshold, may be removed by the 3D model generator 404. Further, the 3D model generator 404 may be configured to generate a colored mesh model based on the colored point cloud.

At block 512, example method 500 may include receiving, via input to the computing system by a second user, a mark associated with one of the 3D models. For example, the computing system 202 may receive marks regarding the real-world objects input by the second user. For example, the second user may annotate the door as “OFFICE ENTRANCE” as shown in FIG. 2 or circle the doorknob to emphasize the office entrance. Additionally, or alternatively, the second user may annotate the direction to the lower left corner of the display as “EXIT TO STREET.” The marks may be displayed adjacent to the 3D models of the door and the floor at the lower left corner with arrows to further describe the objects.

At block 514, example method 500 may include transmitting, by the computing system, information that identifies the mark to the wearable visual enhancement device. For example, information that identifies the marks may be transmitted back to the wearable visual enhancement device 102 by the communication unit 402.

At block 516, example method 500 may include displaying, by the wearable visual enhancement device, the mark adjacent to the object corresponding to the one of the 3D models. For example, the wearable visual enhancement device 102 may be configured to display the marks sufficiently adjacent to the real-world objects in a near-eye display. In other words, from the perspective of the first user, the marks are displayed adjacent to the real-world objects in the field-of-view of the first user. As such, the first user may receive additional information from the second user regarding objects in the first user's field-of-view.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

We claim:

1. A remote assistance system, comprising:
a wearable visual enhancement device at a first location configured to:
scan a scene in a real world in a forward field-of-view of a first user,
generate sensor data associated with one or more objects in the scene, and
transmit the sensor data; and
a computing system at a second location configured to:
receive the sensor data,
generate a 3D scene including 3D models of the one or more objects,
receive, via input by a second user, a mark associated with one of the 3D models, and
transmit information that identifies the mark to the wearable visual enhancement device, wherein the wearable visual enhancement device is further configured to display the mark adjacent to the object corresponding to the one of the 3D models.

2. The remote assistance system of claim 1, wherein the wearable visual enhancement device includes a camera configured to collect color information of a color image of the scene, a depth camera configured to collect distance information of a depth image of the scene, and an inertial measurement unit (IMU) configured to collect acceleration and angular velocity of the wearable visual enhancement device.

3. The remote assistance system of claim 2, wherein the wearable visual enhancement device includes a tracker configured to generate degree of freedom (DoF) information at least partially based on the acceleration and angular velocity.

4. The remote assistance system of claim 3, wherein the wearable visual enhancement device includes a first communication unit configured to transmit the DoF information, the color information of the color image, and the distance information of the depth image to the computing system at the second location.

5. The remote assistance system of claim 3, wherein the wearable visual enhancement device further includes an image integration unit configured to combine the color information of the color image, the distance information of the depth image, and the DoF information that share a timestamp into a frame.

6. The remote assistance system of claim 4, wherein the computing system includes a second communication unit configured to receive the DoF information, the color information, and the distance information.

7. The remote assistance system of claim 6, wherein the computation system includes a 3D model generator configured to generate the 3D scene based on the received DoF information, the color information, and the distance information.

8. The remote assistance system of claim 1, wherein the computing system is further configured to adjust a virtual perception of the second user in the 3D scene in response to users inputs from the second user.

9. A method for remote assistance, comprising:
scanning, by a wearable visual enhancement device at a first location, a scene in a real world in a forward field-of-view of a first user;
generating, by the wearable visual enhancement device, sensor data associated with one or more objects in the scene;
generating, by a computing system at a second location, a 3D scene including 3D models of the one or more objects;
receiving, via input to the computing system by a second user, a mark associated with one of the 3D models;
transmitting, by the computing system, information that identifies the mark to the wearable visual enhancement device; and
displaying, by the wearable visual enhancement device, the mark adjacent to the object corresponding to the one of the 3D models.

10. The method of claim 9, further comprising:
collecting, by a camera of the wearable visual enhancement device, color information of a color image of the scene;
collecting, by a depth camera of the wearable visual enhancement device, distance information of a depth image of the scene; and
collecting, by an inertial measurement unit (IMU), acceleration and angular velocity of the wearable visual enhancement device.

11. The method of claim 10, further comprising generating, by a tracker, degree of freedom (DoF) information at least partially based on the acceleration and angular velocity.

12. The method of claim 11, further comprising transmitting, by a first communication unit, the DoF information, the color information of the color image, and the distance information of the depth image to the computing system at the second location.

13. The method of claim 12, further comprising combining, by an image integration unit, the color information of the color image, the distance information of the depth image, and the DoF information that share a timestamp into a frame.

14. The method of claim 12, further comprising receiving, by a second communication unit, the DoF information, the color information, and the distance information.

15. The method of claim 14, further comprising generating, by a 3D model generator, the 3D scene based on the received DoF information, the color information, and the distance information.

16. The method of claim 9, further comprising adjusting, by the computing system, a virtual perception of the second user in the 3D scene in response to users inputs from the second user.

17. A wearable visual enhancement device, comprising,
a camera configured to collect color information of a color image of a scene,
a depth camera configured to collect distance information of a depth image of the scene,
an inertial measurement unit (IMU) configured to collect acceleration and angular velocity of the wearable visual enhancement device,
a near eye display,
a processor, and
a non-transitory computer readable medium that store instructions, when executed by the processor, causes the processor to:
scan a scene in a real world in a forward field-of-view of a first user by the camera and the depth camera,
generate sensor data associated with one or more objects in the scene by the inertial measurement unit (IMU), and transmit the sensor data to a computing system at a second location;
receive, from the computing system at the second location, a mark associated with a first object in the scene, and
display the mark adjacent to the first object by the near-eye display.

18. The wearable visual enhancement device of claim 17, wherein the instructions further cause the processor to generate degree of freedom (DoF) information at least partially based on the acceleration and angular velocity.

19. The wearable visual enhancement device of claim 18, wherein the wearable visual enhancement device includes a first communication unit configured to transmit the DoF information, the color information of the color image, and the distance information of the depth image to the computing system at the second location.

20. The wearable visual enhancement device of claim 18, wherein the instructions further cause the processor to combine the color information of the color image, the distance information of the depth image, and the DoF information that share a timestamp into a frame.
